(19) United States
(12) Patent Application Publication
(10) Pub. No.: US 2015/0058151 A1
(43) Pub. Date: Feb. 26, 2015

(54) SYSTEMS AND METHODS FOR BUYING AND SELLING ONE OR MORE VEHICLES

(71) Applicant: Cox Digital Exchange, LLC, Atlanta, GA (US)

(72) Inventors: Paul David Sims, Atlanta, GA (US); Greg Easterly, Atlanta, GA (US); Stan Green, Atlanta, GA (US); Don Richards-Boeff, Atlanta, GA (US); Bill Reidy, Atlanta, GA (US)

(73) Assignee: Cox Digital Exchange, LLC, Atlanta, GA (US)

(21) Appl. No.: 14/286,474

(22) Filed: May 23, 2014

Related U.S. Application Data
(60) Provisional application No. 61/868,264, filed on Aug. 21, 2013.

(51) Int. Cl. G06Q 30/08

(52) U.S. Cl. CPC G06Q 30/08
USPC 705/26.3

(57) ABSTRACT

Systems and methods for buying and selling one or more vehicles are provided herein. In one embodiment, the systems and methods disclosed herein may provide a guarantee price to a seller of a vehicle. In another embodiment, the systems and methods disclosed herein may provide a fee associated with receiving the guarantee price for the vehicle. Further, in an additional embodiment, the systems and methods disclosed herein may facilitate the purchase and/or execution of a put option for the vehicle.

### CROSS REFERENCE TO RELATED APPLICATIONS

This application claims the benefit of and priority to U.S. provisional patent application No. 61/868,264, entitled “Systems and Methods for Buying and Selling One or More Vehicles,” filed on Aug. 21, 2013, which is hereby incorporated by reference in its entirety.

### BACKGROUND

Sellers of vehicles are often interested in finding cost-effective means for ensuring profits and/or limiting losses. To this end, sellers generally seek to sell their vehicles by way of a number of channels, including wholesale markets and retail markets. Nevertheless, current vehicle marketplaces may not provide adequate assurances that the sellers will sell their vehicles for at least a certain price, thereby limiting downside.

### BRIEF DESCRIPTION OF THE DRAWINGS

The detailed description is set forth with reference to the accompanying drawings, which are not necessarily drawn to scale. The same reference numbers in different figures indicate similar or identical items.

FIG. 1 is a block diagram of an illustrative system, according to an embodiment of the disclosure.

FIG. 2 is an example flow diagram, according to an embodiment of the disclosure.

FIG. 3 is an example flow diagram, according to an embodiment of the disclosure.

FIG. 4 is an example flow diagram, according to an embodiment of the disclosure.

### DETAILED DESCRIPTION

### Overview

Illustrative embodiments of the disclosure will now be described more fully hereinafter with reference to the accompanying drawings, in which some, but not all embodiments are shown. The disclosure may be embodied in many different forms and should not be construed as limited to the embodiments set forth herein; rather, these exemplary embodiments are provided so that this disclosure will satisfy applicable legal requirements. As noted above, like numbers refer to like elements throughout.

Embodiments of the present disclosure are directed to, among other things, systems and methods for buying and selling one or more vehicles. In certain embodiments, the vehicles may be bought and sold through a service provider via a platform that provides the vehicles to potential buyers, sellers, dealers, traders, wholesalers, retailers, and/or combinations thereof. For example, dealers, traders, wholesalers, and/or retailers may act as both buyers and sellers on the platform.

In one embodiment, a seller may place a vehicle for sale on the platform. For example, information about the vehicle may be obtained and/or provided to the platform by the seller and/or a third-party service provider. The vehicle information may include, but is not limited to, make, model, year, color, trim, condition, mileage, options, history report, comparable sales, etc. Based on the vehicle information, the platform may determine a value of the vehicle. Based on the value of the vehicle, the platform further may determine an offer price for the vehicle, which may be provided to the seller. A number of additional buyers may provide an offer. In some instances, the seller may pay a fee in order to receive the offer price for the vehicle. The seller can choose to accept or decline the offer price for the vehicle. If the seller accepts the offer price for the vehicle, the offer price becomes a firm offer that expires at the end of a sales window, such as a timed auction. In other instances, the seller may accept the offer and complete the transaction without placing the vehicle in a timed auction.

In some instances, after the offer price for the vehicle is accepted by the seller, the vehicle may be placed in a timed auction. That is, the vehicle may be placed in an auction with a specified ending time. By putting the vehicle into the timed auction, the seller agrees that it will accept the highest bid made during the timed auction for the vehicle, provided that the highest bid at least matches the offer price for the vehicle. During the timed auction, one or more buyers may bid on the vehicle. At the end of the timed auction, if no bids at least match or exceed the offer price, the seller has the option to divest (e.g., sell) the vehicle to the platform (or an affiliate, representative, agent, third party, or the like) for the offer price.

In a sense, the offer price for the vehicle comprises a guarantee price. That is, the offer price for the vehicle is a guaranteed offer to the seller at the end of a sales window, such as a timed auction. For example, if the seller does not receive adequate bids during or after the timed auction, the seller can accept the offer price for the vehicle. The offer price may provide the seller with assurances during the timed auction that the seller can at least sell the vehicle for the offer price during or after the timed auction if no bids at least match or exceed the offer price.

In some instances, the minimum bid of the timed auction may be at least equal to the offer price for the vehicle. In other instances, the reserve price for the vehicle may be at least equal to the offer price for the vehicle. In other instances, the minimum bid may be set by the seller higher or lower than the offer price. Similarly, the seller may, in some instances, set the reserve price higher or lower than the offer price.

In another embodiment, a seller may place a vehicle for sale in a timed auction via the platform. One or more buyers may bid on the vehicle during the timed auction. Prior to the start of the timed auction, however, the platform may determine a value of the vehicle based on the vehicle information. In addition, based on the value of the vehicle, the platform may determine an offer price for the vehicle. The offer price is the price the platform is willing to pay the seller for the vehicle. Further, based on the vehicle information, the value of the vehicle, and/or the offer price, the platform may determine a fee associated with the offer price. The fee associated with the offer price is the fee the seller has to pay in order to receive the offer price from the platform prior to the timed auction. That is, the seller may purchase the right to receive the offer price from the platform before the timed auction.

By paying to receive the offer price, the seller obtains a firm offer before the timed auction that the seller can accept during or after the timed auction. The offer price may be a specific amount or a range (e.g., within 5% of the reserve price). At the end of the timed auction, if no bids at least match or exceed the offer price, the seller can divest (e.g., sell) the vehicle to the platform (or an affiliate, representative, agent, third party, or the like) for the offer price. Otherwise, the seller agrees that it will accept the highest bid made during the timed auction, provided that the highest bid at least matches the offer price for the vehicle and is greater than or equal to the minimum bid and/or reserve price.

In an additional embodiment, the seller may purchase a put option to sell a vehicle. For example, information about the vehicle may be obtained and/or provided to the platform by the seller and/or a third-party service provider. Based on the vehicle information, the platform may determine a value of the vehicle. Based on the value of the vehicle, the platform further may determine an offer price for the vehicle. Further, based on the vehicle information, the value of the vehicle, the offer price, and/or one or more parameters associated with the put option (such as when the put option can be exercised and/or when the put option expires), the platform may determine a fee associated with the offer price. For the fee, the seller may purchase from the platform the right to exercise the offer price at a further date and time. For example, the seller may have a vehicle that is just entering its lot or that has been on its lot but is not yet at the point of being a divestiture due to age. The seller can choose to purchase a put option from the platform to sell the vehicle. In effect, the seller is buying a minimum sale price on the vehicle—limiting downside—and retaining the ability to pursue a retail or wholesale sale—maintaining upside.

In some instances, the option can be exercised at any time up until the expiration of the put option, only at set times, or only at the end of the put option term. For example, the seller may purchase a put option from the platform and thereafter place the vehicle in a timed auction. If the seller does not receive adequate bids during or after the timed auction, the seller can exercise the put option prior to the expiration thereof.

In some instances, the option may not vest until a further date. In this manner, if a seller (such as a dealer) purchases the option, the seller can afford to be selective in the offers it may choose to consider for a particular vehicle knowing that at the further date when the option vests, the seller can claim the option and receive a set amount in exchange for the vehicle. The date the option vests could vary, but it would likely be related to the curtailment period for most lenders (either just before curtailment, just after curtailment, or coincident with curtailment).

In various embodiments, if the offer price is accepted by the seller or the put option is exercised by the seller, the platform (or a representative, affiliate, agent, or partner thereof) may purchase the vehicle. In this case, the platform may make the appropriate arrangements for inspecting, transporting, and/or reselling the vehicle. The transactional costs associated with purchasing the vehicle may be factored into the offer price and/or the fee associated with the offer price.

As noted above, in certain embodiments, the platform may determine wholesale, retail, and/or other values for each vehicle in the platform. In some examples, a wholesale and/or a retail value may be provided by a third-party vehicle valuation service, or it may be determined by the platform. For example, the value may be based on the condition of the vehicle, mileage, the year, trim, options, the make and/or model of the vehicle, and/or market conditions, such as real-time market conditions, related to similar vehicles. Additionally, in some examples, the determined market value may be compared against the vehicle listing price and/or offers being received from potential buyers for the same or similar vehicles.

In some aspects, the offer price may be based on several factors and/or combinations of factors. For example, the offer price may be based at least in part on the determined value and/or the projected (or predicted) resale price of the vehicle at auction or elsewhere. In this manner, the offer price may comprise a percentage (such as 92%, 87%, 60%, or the like) of the determined value and/or predicted resale price of the vehicle. Additionally, the offer price may be determined based on one or more vehicle properties as indicated by the seller or received from one or more third-party service providers. Vehicle properties may include, without limitation, the vehicle condition, make, model, mileage, vehicle identification number (VIN), features, options, trims, quality characteristics, recalls, current events (e.g., sudden accelerations, etc.), rollovers, tire failures, etc. Moreover, in some examples, real-time market activity surrounding the vehicle or similar vehicles that are being sold may be utilized. For example, the vehicle history report of the vehicle may be used as a factor to determine the offer price, and/or sales prices of related vehicles may be used to determine the offer price as may market size (e.g., for super luxury vehicles, or highly modified vehicles). Further, the actual or predicted costs associated with inspecting, transporting, reconditioning, and/or reselling the vehicle at auction or elsewhere may be used as a factor to determine the offer price.

By way of example and without limitation, real-time market conditions may include conditions that are determined based on real-time, or near real-time, data. That is, data may be updated continuously over a period of time such as, but not limited to, every second, every minute, every hour, every day, every week, etc., or any appropriate interval based on the context. For example, and as those of skill in the art will understand, different contexts may create different understandings of real-time (e.g., in the new and/or used automobile market, real-time market conditions may imply market conditions that change throughout a day or even a week).

In some examples, sellers may be vehicle owners who wish to sell or exchange their vehicles, or those with the authority from the owners. Additionally, buyers may be those people or entities that receive vehicles in exchange for money. Generally, but not always, the vehicle buyer may intend, or attempt, to resell the vehicle that was received. Further, in some embodiments, such real time or near real time data may be supplemented by recent or historical data.

The platform may be accessible over a public or private network, such as the Internet (which throughout this Detailed Description should be read to also include mobile web and mobile networking), by one or more users (i.e., buyers and sellers). These users, according to one example embodiment, may interact with a server, or other computing device, of the platform by way of software implementation on a computing device of the users and/or via a Web application of the platform.

While many of the embodiments of the disclosure are described in terms of vehicles, those of skill in the art will understand that the disclosure is not so limited, and other products, as described herein, could be substituted for vehicles. For example, other items may be sold using the systems and methods described herein. As an overview, items may be any products or services that may be sold or exchanged including, for example, and without limitation, vehicles, vehicle parts, computer products, firearms, articles of clothing, gemstones, jewelry, consumer electronics, electronics parts, yard appliances, construction machines and equipment, aircrafts, boats, office equipment, furniture, manufacturing equipment, packaging equipment, kitchen equipment, appliances, raw materials, mineral rights, water rights, combinations of the foregoing, or the like, or related products and components.

This brief introduction, including section titles and corresponding summaries, is provided for the reader's convenience and is not intended to limit the scope of the claims, nor the proceeding sections. Furthermore, the techniques described above and below may be implemented in a number of ways and in a number of contexts. Several example implementations and contexts are provided with reference to the following figures, as described below in more detail. However, the following implementations and contexts are but a few of many.

### Illustrative Architecture

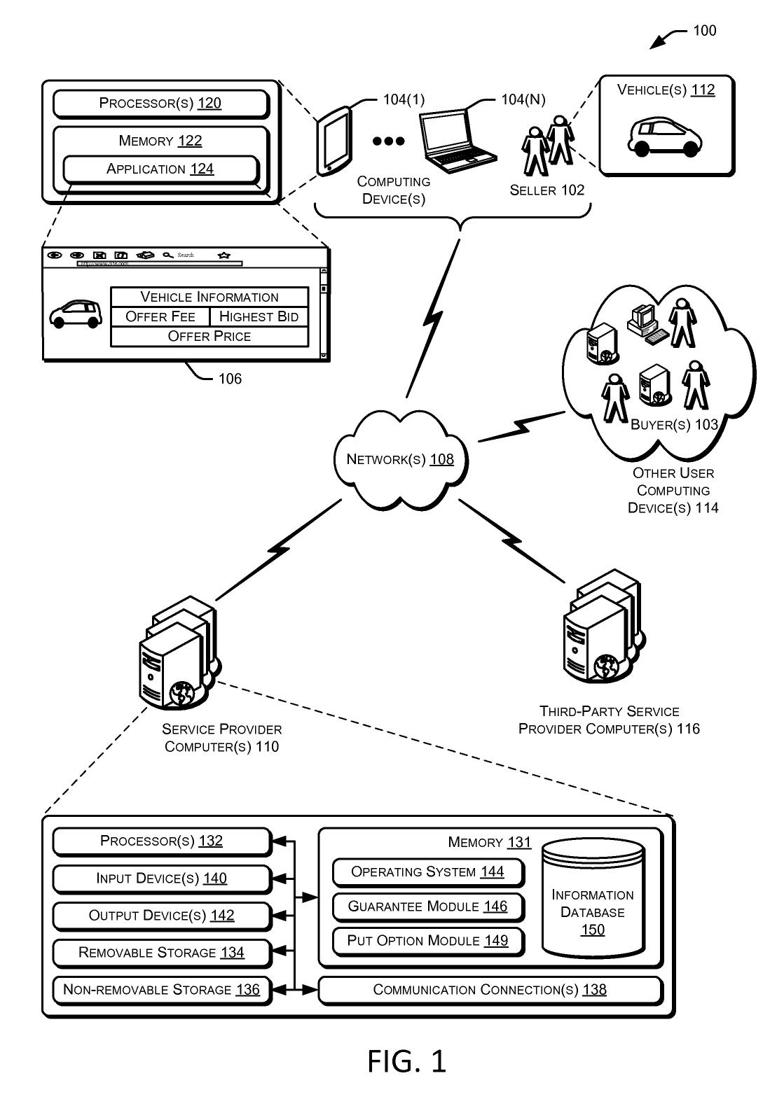

FIG. 1 depicts an illustrative system or architecture 100 in which techniques for buying and selling one or more vehicles may be implemented. In architecture 100, a seller 102 may utilize computing devices 104(1), . . . , 104(N) to access a client application interface (or website) 106 that may be provided by, created by, or otherwise associated with a service provider via one or more networks 108. In some instances, the computing devices 104 may be configured to present or otherwise display the client application interface 106 to the seller 102. The networks 108 may include any one or a combination of multiple different types of networks, such as cable networks, the Internet, wireless networks, and other private and/or public networks.

While the illustrated example represents the seller 102 accessing the client application interface 106 over the networks 108, the described techniques may equally apply in instances where the seller 102 interacts with a service provider via a personal computer, over the phone, via a kiosk, or in any other manner. It is also noted that the described techniques may apply in other client/server arrangements (e.g., set-top boxes, etc.), as well as in non-client/server arrangements (e.g., locally stored software applications, etc.).

In some aspects, the client application interface 106 may allow the seller 102 to access, receive from, transmit to, or otherwise interact with the service provider via one or more service provider computers 110. The computing devices 104 may be any type of computing devices including, but not limited to, desktop personal computers (PCs), laptop PCs, mobile phones, smart phones, mobile devices, personal digital assistants (PDAs), tablet PCs, game consoles, set-top boxes, wearable computers, e-readers, web-enabled TVs, cloud-enabled devices and work stations, and the like. In some instances, and as illustrated, each computing device 104 may be equipped with one or more processors 120 and memory 122 to store applications and data, such as application 124 that may display the client application interface 106 and/or enable access to the website stored on the service provider computers 110 or elsewhere. In this manner, the service provider computers 110 may facilitate the sale of one or more vehicles 112 by the seller 102.

The architecture 100 may also include one or more buyers 103 operating one or more other user computing devices 114. The computing devices 114 may be any type of computing devices including, but not limited to, desktop personal computers (PCs), laptop PCs, mobile phones, smart phones, mobile devices, personal digital assistants (PDAs), tablet PCs, game consoles, set-top boxes, wearable computers, e-readers, web-enabled TVs, cloud-enabled devices and work stations, and the like. Similar to the computing devices 104, each of the computing devices 114 may be equipped with one or more processors and memory to store applications and data that may display the client application interface and/or enable access to the website stored on the service provider computers 110 or elsewhere. In other examples, the computing devices 114 may be any type of computing devices such as, but not limited to, mobile, desktop, and/or cloud computing devices, such as servers. In some examples, the computing devices 114 may be in communication with the service provider computers 110 and/or the computing devices 104 via the networks 108 or via other network connections. In this manner, the service provider computers 110 may facilitate the purchase of the one or more vehicles 112 by the buyers 103.

The architecture 100 may also include one or more third-party services operating one or more third-party service provider computers 116. The third-party service provider computers 116 may be any type of computing devices such as, but not limited to, mobile, desktop, and/or cloud computing devices, such as servers. In some examples, the third-party service provider computers 116 may be in communication with the service provider computers 110, the computing devices 104, and/or the computing devices 114 via the networks 108, or via other network connections. The third-party service provider computers 116 may include one or more servers, perhaps arranged in a cluster, as a server farm, or as individual servers not associated with one another.

The third-party service provider computers 116 may be configured to provide information associated with the vehicles 112. For example, the third-party services may include, but are not limited to, vehicle appraisal services, vehicle auction services, arbitration services, vehicle listing services, vehicle information aggregation services (e.g., services that determine market values for vehicles based on aggregated information associated with those vehicles), financial institutions, credit institutions, vehicle auction companies, vehicle brokerage services, and the like. As such, when requested by the service provider computers 110, the third-party service provider computers 116 may provide vehicle information. In some examples, this information may be utilized by the service provider computers 110 to determine a value for the vehicle, an offer price for the vehicle, a fee associated with the offer price, a fee to purchase a put option for the vehicle, and/or transaction costs associated with the sale of a vehicle 112.

The service provider computers 110 may be any type of computing devices such as, but not limited to, mobile, desktop, and/or cloud computing devices, such as servers. In some examples, the service provider computers 110 may be in communication with the computing devices 104, the computing devices 114, and/or the third-party service provider computers 116 via the networks 108, or via other network connections. The service provider computers 110 may include one or more servers, perhaps arranged in a cluster, as a server farm, or as individual servers not associated with one another. These servers may be configured to host a website viewable via the client application interface 106 or any other Web browser accessible by the seller 102, the buyers 103, and/or one or more third parties.

In some instances, through the client application interface 106, the seller 102 may provide information associated with the vehicle 112 that the seller 102 would like to sell. In other instances, information about vehicles 112 may be provided to the service provider computers 110 by third-party providers via the third-party service provider computer 116, such as, but not limited to, Dealer Management Systems (DMSs), other inventory management systems, other inventory data feeds, valuation services, financial institutions, vehicle brokers, or the like.

The seller 102 may receive one or more offers from the buyers 103, the service provider computers 110, and/or the third-party service provider computers 116. For example, as discussed in greater detail below, the seller 102 may receive an initial offer from the service provider computers 110 to purchase the vehicle 112. Thereafter, the seller 102 may receive additional offers by the buyers 103 in an auction style sale. The seller 102 may then choose to sell the vehicle 112 to the service provider, the buyers 103, or the third-party service provider computers 116. In another embodiment, the seller 102 may purchase a put option on the vehicle 112 via the service provider computers 110. The put option may be purchased from the service provider, the buyers 103, and/or a third party. In this manner, the seller 102 may exercise the put option at a further time and date.

In one illustrative configuration, the service provider computers 110 comprise at least a memory 131 and one or more processing units (or processor(s)) 132. The processor(s) 132 may be implemented as appropriate in hardware, software, firmware, or combinations thereof. Software or firmware implementations of the processor(s) 132 may include computer-executable or machine-executable instructions written in any suitable programming language to perform the various functions described.

Memory 131 may store program instructions that are loadable and executable on the processor(s) 132, as well as data generated during the execution of these programs. Depending on the configuration and type of service provider computer 110, memory 131 may be volatile (such as random access memory (RAM)) and/or non-volatile (such as read-only memory (ROM), flash memory, etc.). The service provider computer 110 or server may also include additional removable storage 134 and/or non-removable storage 136 including, but not limited to, magnetic storage, optical disks, and/or tape storage. The disk drives and their associated computer-readable media may provide non-volatile storage of computer-readable instructions, data structures, program modules, and other data for the computing devices. In some implementations, the memory 131 may include multiple different types of memory, such as static random access memory (SRAM), dynamic random access memory (DRAM), or ROM.

The memory 131, the removable storage 134, and the non-removable storage 136 are all examples of computer-readable storage media. For example, computer-readable storage media may include volatile and non-volatile, removable and non-removable media implemented in any method or technology for storage of information such as computer-readable instructions, data structures, program modules, or other data. Memory 131, removable storage 134, and non-removable storage 136 are all examples of computer storage media. Additional types of computer storage media that may be present include, but are not limited to, programmable random access memory (PRAM), SRAM, DRAM, RAM, ROM, electrically erasable programmable read-only memory (EEPROM), flash memory or other memory technology, compact disc read-only memory (CD-ROM), digital versatile discs (DVDs) or other optical storage, magnetic cassettes, magnetic tape, magnetic disk storage or other magnetic storage devices, or any other medium which can be used to store the desired information and which can be accessed by the service provider computer 110 or other computing devices. Combinations of any of the above should also be included within the scope of computer-readable media.

Alternatively, computer-readable communication media may include computer-readable instructions, program modules, or other data transmitted within a data signal, such as a carrier wave, or other transmission. However, as used herein, computer-readable storage media does not include computer-readable communication media.

The service provider computer 110 may also contain communication connection(s) 138 that allow the service provider computer 110 to communicate with a stored database, another computing device or server, user terminals, and/or other devices on a network. The service provider computer 110 may also include input device(s) 140 such as a keyboard, a mouse, a pen, a voice input device, a touch input device, etc., and output device(s) 142, such as a display, speakers, printers, etc.

Turning to the contents of the memory 131 in more detail, the memory 131 may include an operating system 144 and one or more application programs or services for implementing the features disclosed herein, including a guarantee module 146, a put option module 149, and/or an information database 150. In certain embodiments, the guarantee module 146 may be configured to determine a guarantee offer price for the vehicle 112 for sale. For example, the seller 102 may offer the vehicle 112 for sale by way of the service provider computer 110.

In some instances, information about the vehicle 112 may be obtained and/or provided to the service provider computer 110 by the seller 102. For example, the seller 102 may scan (or capture an image) of a VIN of the vehicle 112 and transmit it over the network 108 to the service provider computers 110, the buyers 103, and/or the third-party service provider computers 116. Based on the vehicle information provided by the seller 102, additional vehicle information may be obtained. Other vehicle information may be provided by the seller 102, including photos, recordings, history reports, etc. The vehicle information may be stored in the information database 150.

In other instances, information about the vehicle 112 may be obtained and/or provided to the service provider computer 110 by way of the third-party service provider computers 116. The vehicle information may include, but is not limited to, a VIN number, a make, a model, a year, a condition, a color, a trim, options, a value, a mileage, an image, a history report, a recording, a video, a location, a seller, an inventory identifier, an indicator whether the vehicle is subject to floorplan financing, an amount of time the vehicle has been in a particular inventory, and/or an amount of time the vehicle has been available for exchange, trade, and/or sale. Other vehicle information may also be used herein. The vehicle information may be stored in the information database 150.

Based on the vehicle information, the guarantee module 146 may determine a value of the vehicle 112. For example, the service provider computer 110 may be provided with a value for the vehicle 112 by way of the third-party service provider computers 116, which may include a third-party valuation service provider. The value information may be stored in the information database 150.

Based on the value of the vehicle 112, the guarantee module 146 may further determine an offer price for the vehicle 112. For example, the service provider computer 110 may be provided with one or more offer prices for the vehicle 112 by way of the third-party service provider computers 116. In some aspects, the offer price may be based on several factors and/or combinations of factors. For example, the offer price may be based at least in part on the determined value and/or the projected (or predicted) resale price of the vehicle 112 at auction or elsewhere. In this manner, the offer price may comprise a percentage (such as 92%, 87%, 60%, or the like) of the determined value and/or predicted resale price of the vehicle 112. It should be understood that these percentages are only exemplary, and any other percentage could be used. Additionally, the offer price may be determined based on one or more vehicle properties as indicated by the seller 102 or received from one or more third-party service provider computers 116. The offer price may be stored in the information database 150.

The guarantee module 146 may be configured to provide the offer price to the seller 102 via the computing devices 104 over the networks 108. In some instances, the seller 102 may pay a fee in order to receive the offer price for the vehicle 112.

In response to the offer price, the seller 102 can choose to accept or decline the offer price for the vehicle 112. If the seller 102 accepts the offer price for the vehicle 112, the offer price becomes a firm offer that expires at the end of a sales window, such as a timed auction. For example, after the offer price for the vehicle 112 is accepted by the seller 102, the vehicle 112 is placed in a timed auction. By putting the vehicle into the timed auction, the seller 102 agrees that it will accept the highest bid made during the timed auction for the vehicle 112, provided that the highest bid at least matches the offer price for the vehicle 112. During the timed auction, the one or more buyers 103 may bid on the vehicle 112. At the end of the timed auction, if no bids from the buyers 103 at least match or exceed the offer price, the seller 102 has the option to divest (i.e., sell) the vehicle 112 to the service provider for the offer price.

The offer price for the vehicle 112 comprises a guarantee price. That is, the offer price for the vehicle 112 is a guaranteed offer to the seller at the end of the timed auction. For example, if the seller 102 does not receive adequate bids during or after the timed auction, the seller 102 can accept the offer price for the vehicle 112. The offer price may provide the seller 102 with assurances during the timed auction that the seller 102 can at least sell the vehicle 112 for the offer price during or after the timed auction if no bids at least match or exceed the offer price.

In some instances, the minimum bid of the timed auction may be at least equal to the offer price for the vehicle 112. In other instances, the reserve price for the vehicle 112 may be at least equal to the offer price for the vehicle 112.

In some instances, the guarantee module 146 may be configured to determine a fee associated with providing the seller 102 with the offer price. For example, prior to the start of the timed auction, the guarantee module 146 may determine, based on the vehicle information, the value of the vehicle 112, and/or the offer price and a fee associated with the offer price. The fee associated with the offer price is the fee the seller 102 has to pay in order to receive the offer price from the service provider prior to the timed auction. That is, the seller 102 may purchase the right to receive the offer price from the service provider before the timed auction. By paying the fee to receive the offer price, the seller 102 obtains a firm offer before the timed auction that the seller 102 can accept during or after the timed auction. At the end of the timed auction, if no bids at least match or exceed the offer price, the seller 102 can sell the vehicle 112 to the service provider for the offer price. Otherwise, the seller 102 agrees that it will accept the highest bid made during the timed auction by the buyers 103, provided that the highest bid at least matches the offer price for the vehicle 112 and is greater than or equal to the minimum bid and/or reserve price.

In some instances, the offer price may be a specific amount. For example, the offer price for the vehicle 112 may be $20,000. In other instances, the offer price may be a range. For example, the offer price may comprise a percentage of the reserve price. In one example, if the reserve price is $15,000, the offer price may be an offer that is within 5% of the reserve price. In this manner, the seller 102 knows that it will at least get an offer at the end of the timed auction ranging from $14,250 to $15,750 for the vehicle 112.

In certain embodiments, the put option module 149 may be configured to determine a fee associated with purchasing a put option for the vehicle 112 for sale by the seller 102. For example, the seller 102 may purchase a firm offer from the service provider via the service provider computers 110 that can be exercised at a further date and time. For example, based on the vehicle information, the put option module 149 may determine a value of the vehicle 112. Based on the value of the vehicle 112, the put option module 149 further may determine an offer price for the vehicle 112. Further, based on the vehicle information, the value of the vehicle 112, the offer price, and/or one or more parameters associated with the put option (such as when the put option can be exercised and/or when the put option expires), the put option module 149 may determine a fee associated with the offer price. For the fee, the seller 102 may purchase from the service provider the right to exercise the offer price at a further date and time. For example, the seller 102 can choose to purchase a put option from the service provider. Thereafter, the seller 102 can attempt to sell the vehicle 112 (perhaps in a timed auction) via the service provider computers 110 and/or via other retail channels. If at the end of the timed auction, the seller 102 does not receive adequate bids on the vehicle 112, the seller 102 may exercise the put option and sell the vehicle 112 to the service provider. In effect, the seller 102 is buying a minimum sale price on the vehicle 112 (thereby limiting downside) and retaining the ability to pursue a retail sale (thereby maintaining upside).

In some instances, the put option can be exercised at any time up until the expiration of the put option, only at set times, or only at the end of the put option term. For example, the seller 102 may purchase a put option from the platform and thereafter place the vehicle 112 in a timed auction. If the seller 102 does not receive adequate bids during or after the timed auction, the seller 102 can exercise the put option prior to the expiration thereof. The fee associated with purchasing the put option may vary depending on the factors discussed herein, including the expiration of the put option.

In the various embodiments described herein, if the offer price is accepted by the seller 102 or the put option is exercised by the seller 102, the service provider (or an agent, affiliate, representative, partner or the like) may purchase the vehicle 112. In this case, the service provider may make the appropriate arrangements for inspecting, transporting, and/or reselling the vehicle 112. For example, the third-party service provider computers 116 may facilitate the inspection, transportation, and/or reselling of the vehicle 112.

Various instructions, methods, and techniques described herein may be considered in the general context of computer-executable instructions, such as program modules, executed by one or more computers or other devices. Generally, program modules include routines, programs, objects, components, data structures, etc., for performing particular tasks or implementing particular abstract data types. These program modules and the like may be executed as native code or may be downloaded and executed, such as in a virtual machine or other just-in-time compilation execution environment. Typically, the functionality of the program modules may be combined or distributed as desired in various embodiments. An implementation of these modules and techniques may be stored on some form of computer-readable storage media.

The example architecture and computing devices shown in FIG. 1 are provided by way of example only. Numerous other operating environments, system architectures, and device configurations are possible. Accordingly, embodiments of the present disclosure should not be construed as being limited to any particular operating environment, system architecture, or device configuration.

### Illustrative Processes

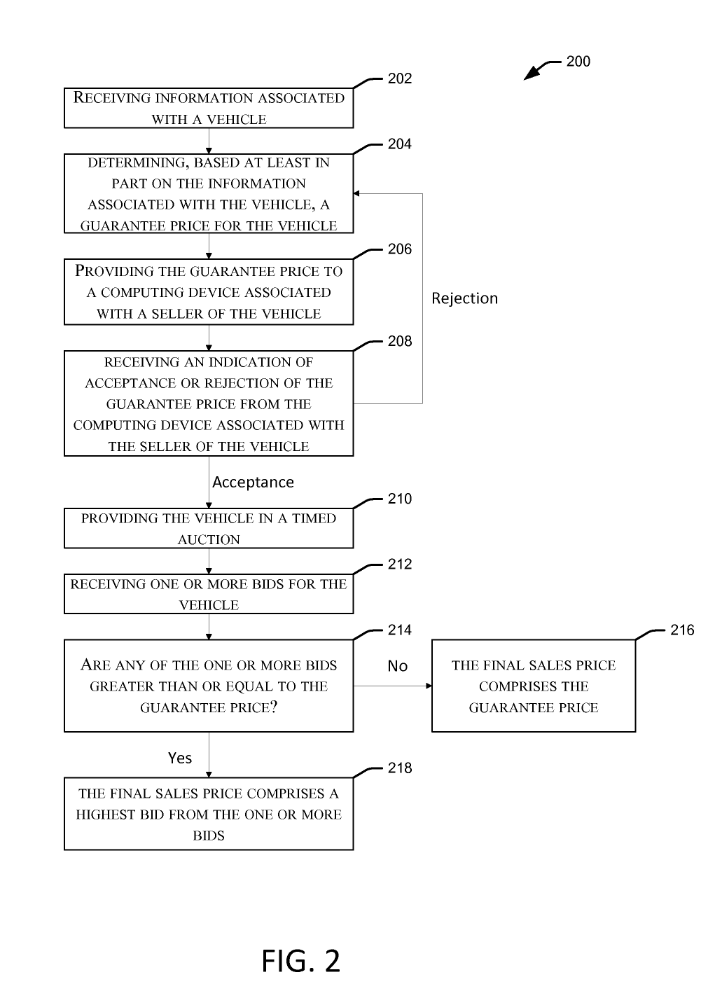

FIGS. 2-4 illustrate example flow diagrams showing processes for providing a service for buying and selling one or more vehicles. These processes are illustrated as logical flow diagrams in which each operation represents a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

The process 200, shown in FIG. 2, may, but need not, be implemented by a computing device operated by a service provider, such as the service provider computers 110. In some aspects, the process 200 may begin by receiving information associated with a vehicle 112 at block 202. In some instances, information about the vehicle 112 may be obtained and/or provided to the service provider computer 110 by the seller 102. In other instances, information about the vehicle 112 may be obtained and/or provided to the service provider computer 110 by way of the third-party service provider computers 116.

At block 204, a guarantee price may be determined. The guarantee price may be at least partially based on the information associated with the vehicle 112. The guarantee price may be provided to the seller 102 at block 206. The guarantee price is a hard offer to the seller 102.

In response to the guarantee price, the seller 102 can choose to accept or reject the guarantee price for the vehicle 112 at block 208. If the guarantee price is rejected, the process may end or a new guarantee price may be determined and presented to the seller 102. If the seller 102 accepts the guarantee price for the vehicle 112, the guarantee price becomes a firm offer that expires at the end of a sales window, such as a timed auction. For example, after the guarantee price for the vehicle 112 is accepted by the seller 102, the vehicle 112 is placed in a timed auction at block 210. By putting the vehicle into the timed auction, the seller 102 agrees that it will accept the highest bid made during the timed auction for the vehicle 112, provided that the highest bid at least matches the guarantee price for the vehicle 112. During the timed auction, the one or more buyers 103 may bid on the vehicle 112 at block 212.

The timed auction may end at block 214. At the end of the timed auction, if no bids from the buyers 103 at least match or exceed the offer price, the seller 102 has the option to sell the vehicle 112 to the service provider for the guarantee price. That is, if at least one bid is greater than or equal to the guarantee price, the highest bid of the auction becomes the final price at block 218. On the other hand, if no bids from the buyers 103 at least match or exceed the guarantee price, then the guarantee price becomes the final price at block 216.

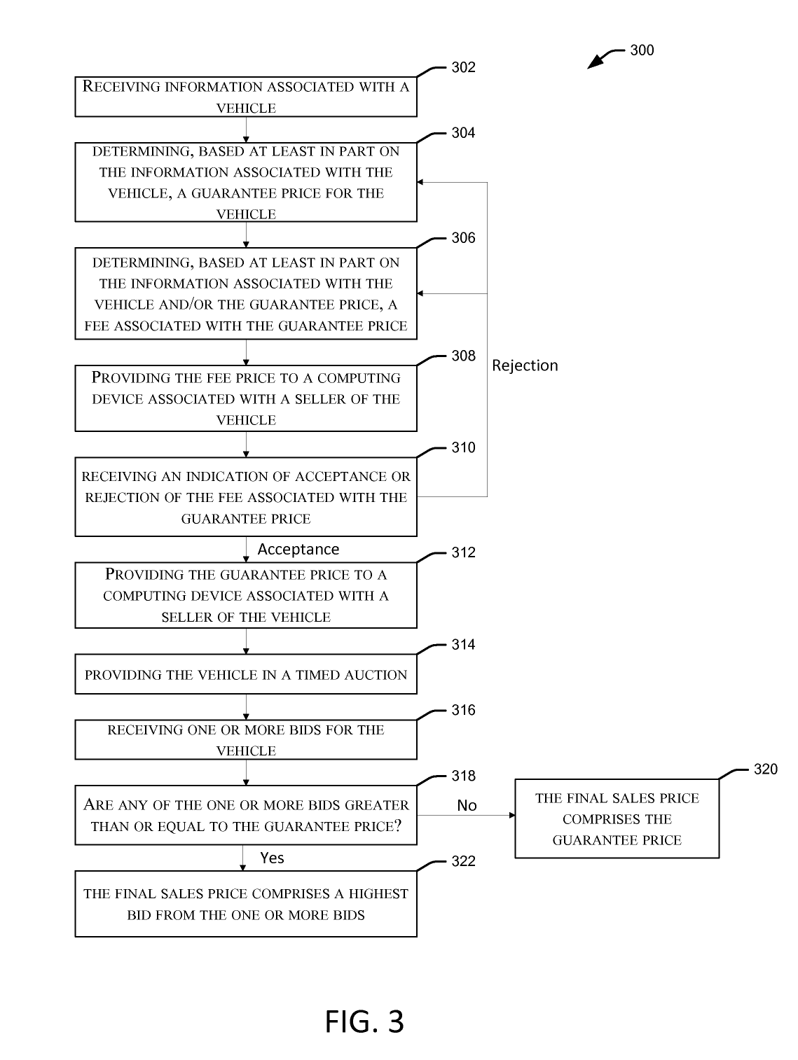

The process 300, shown in FIG. 3, may, but need not, be implemented by a computing device operated by a service provider, such as the service provider computers 110. In some aspects, the process 300 may begin by receiving information associated with a vehicle 112 at block 302. In some instances, information about the vehicle 112 may be obtained and/or provided to the service provider computer 110 by the seller 102. In other instances, information about the vehicle 112 may be obtained and/or provided to the service provider computer 110 by way of the third-party service provider computers 116.

At block 304, a guarantee price may be determined. The guarantee price may be at least partially based on the information associated with the vehicle 112. At block 306, a fee associated with the guarantee price may be determined. The fee associated with the guarantee price may be based at least in part on the information associated with the vehicle 112 and/or the guarantee price. The fee associated with the guarantee price is the fee the seller 102 has to pay in order to receive the guarantee price from the service provider prior to the timed auction. That is, the seller 102 may purchase the right to receive the guarantee price from the service provider before the timed auction. By paying the fee to receive the guarantee price, the seller 102 obtains a firm offer before the timed auction that the seller 102 can accept during or after the timed auction. The fee associated with the guarantee price may be provided to the seller 102 at block 308.

The seller 102 can choose to accept or reject the fee associated with the guarantee price at block 310. If the fee associated with the guarantee price is rejected, the process may end, a new fee associated with the guarantee price may be determined, and/or a new guarantee price may be determined. If the seller 102 accepts the fee associated with the guarantee price, the guarantee price for the vehicle 112 may be provided to the seller 102 at block 312.

The guarantee price may become a firm offer that expires at the end of a sales window, such as a timed auction. For example, after the guarantee price for the vehicle 112 is accepted by the seller 102, the vehicle 112 is placed in a timed auction at block 314. By putting the vehicle 112 into the timed auction, the seller 102 agrees that it will accept the highest bid made during the timed auction for the vehicle 112, provided that the highest bid at least matches the guarantee price for the vehicle 112. During the timed auction, the one or more buyers 103 may bid on the vehicle 112 at block 316. The timed auction may end at block 318. At the end of the timed auction, if no bids from the buyers 103 at least match or exceed the offer price, the seller 102 has the option to sell the vehicle 112 to the service provider for the guarantee price. That is, if at least one bid is greater than or equal to the guarantee price, the highest bid of the auction becomes the final price at block 322. On the other hand, if no bids from the buyers 103 at least match or exceed the guarantee price, then the guarantee price becomes the final price at block 320.

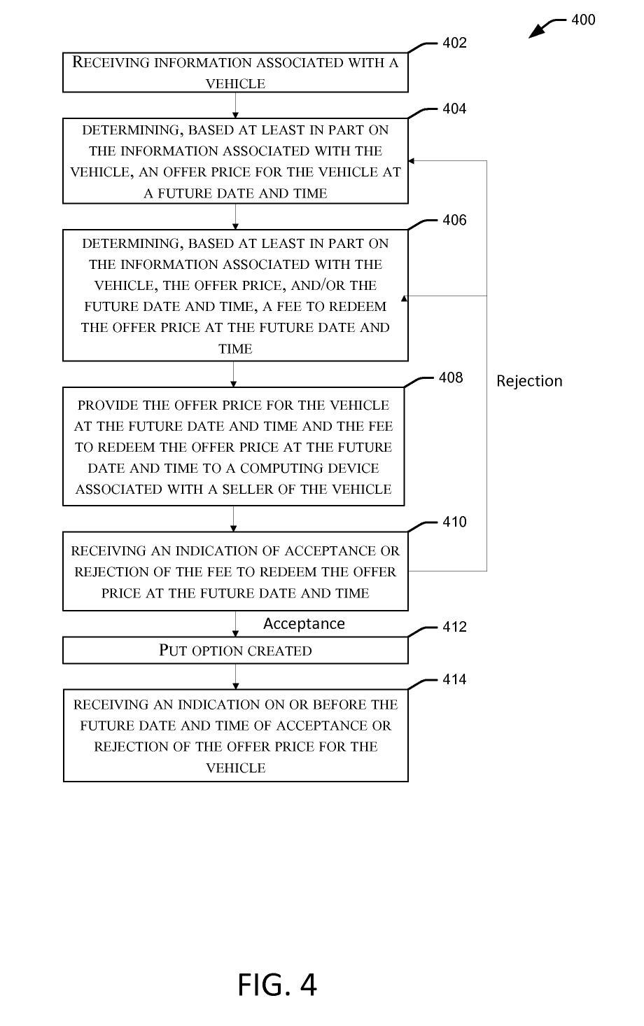

The process 400, as shown in FIG. 4, may, but need not, be implemented by a computing device operated by a service provider, such as the service provider computers 110. In some aspects, the process 400 may begin by receiving information associated with a vehicle 112 at block 402. In some instances, information about the vehicle 112 may be obtained and/or provided to the service provider computer 110 by the seller 102. In other instances, information about the vehicle 112 may be obtained and/or provided to the service provider computer 110 by way of the third-party service provider computers 116.

At block 404, an offer price for the vehicle 112 may be determined based at least in part on the vehicle information. The offer price may be an offer that can be executed at a future time and date. For example, the offer price may be the initial offer of a put option for the vehicle 112. At block 406, a fee associated with the offer price may be determined. The fee associated with the offer price may be based on the vehicle information, the value of the vehicle 112, the offer price, and/or one or more parameters associated with a put option (such as when the put option can be exercised and/or when the put option expires). The offer price for the vehicle 112 and the associated fee may be provided to the seller 102 at block 408.

At block 410, the seller 102 can choose to purchase a put option from the service provider. That is, the seller 102 can accept or reject the fee to purchase the put option. If the seller accepts, a put option is created at block 412. Thereafter, the seller 102 can attempt to sell the vehicle 112 (perhaps in a timed auction) via the service provider computers 110 and/or via other retail or wholesale channels. If at the end of the timed auction, the seller 102 does not receive adequate bids or offers on the vehicle 112, the seller 102 may exercise the put option and sell the vehicle 112 to the service provider at block 414. Also, in some embodiments, the seller 102 may exercise the put option any time prior to the expiration of the put option. In some instances, if the seller 102 rejects the fee to purchase the put option, a new fee may be determined and presented to the seller 102 or the transaction may be canceled.

Illustrative systems and methods for buying and selling one or more vehicles are described above. Some or all of these systems and methods may, but need not, be implemented at least partially by architecture and/or flows such as those shown in FIGS. 1-4 above.

That which is claimed:

1. A method, comprising:
receiving, by at least one processor coupled to at least one memory, information associated with a vehicle;
determining, by the at least one processor and based at least in part on the information associated with the vehicle, a guarantee price for the vehicle;
providing, by the at least one processor, the guarantee price to a computing device associated with a seller of the vehicle;
receiving, by the at least one processor, an indication of acceptance or rejection of the guarantee price from the computing device associated with the seller of the vehicle;
providing, by the at least one processor, the vehicle in a timed auction when the received indication from the computing device associated with the seller of the vehicle comprises acceptance of the guarantee price;
receiving, by the at least one processor, one or more bids for the vehicle; and
determining, by the at least one processor and based at least in part on the one or more bids and the guarantee price, a final sales price of the vehicle at the end of the timed auction, wherein the final sales price comprises (1) a highest bid from the one or more bids in the timed auction that is at least greater than or equal to the guarantee price; or (2) the guarantee price if none of the one or more bids is greater than or equal to the guarantee price.

2. The method of claim 1, further comprising receiving, by the at least one processor, an indication of acceptance or rejection of the final sales price from the computing device associated with the seller of the vehicle.

3. The method of claim 1, wherein the guarantee price comprises a minimum bid price for the vehicle in the timed auction.

4. The method of claim 1, wherein the guarantee price comprises a reserve price for the vehicle in the timed auction.

5. The method of claim 1, wherein the information associated with the vehicle is received from the seller of the vehicle via the computing device associated with the seller of the vehicle.

6. The method of claim 1, wherein the information associated with the vehicle is received from one or more third-party service providers via one or more third-party service provider computers.

7. The method of claim 1, wherein the guarantee price is based at least in part on a value of the vehicle as provided by one or more third-party service providers via one or more third-party service provider computers.

8. The method of claim 1, wherein the guarantee price comprises at least one of a specific amount, a range of amounts, or at least a percentage of an amount.

9. The method of claim 1, further comprising:
determining, by the at least one processor, a fee associated with the guarantee price;
providing, by the at least one processor, the fee associated with the guarantee price to the computing device associated with the seller of the vehicle before the timed auction; and
receiving, by the at least one processor, an indication of acceptance or rejection of the fee associated with the guarantee price from the computing device associated with the seller of the vehicle before the timed auction.

10. The method of claim 9, further comprising providing the fee associated with the guarantee price to the computing device associated with the seller before providing the computing device associated with seller with the guarantee price.

11. The method of claim 9, wherein the fee associated with the guarantee price is only provided to the computing device associated with the seller if the fee is accepted.

12. One or more computer-readable media storing computer-executable instructions that, when executed by at least one processor, configure the at least one processor to perform operations comprising:
receiving information associated with a vehicle;
determining, based at least in part on the information associated with the vehicle, a guarantee price for the vehicle;
determining, based at least in part on the information associated with the vehicle and/or the guarantee price, a fee associated with the guarantee price;
providing the fee to a computing device associated with a seller of the vehicle;
receiving an indication of acceptance or rejection of the fee from the computing device associated with the seller of the vehicle;
providing the guarantee price to the computing device associated with the seller of the vehicle when the received indication comprises acceptance of the fee;
providing the vehicle in a timed auction;
receiving one or more bids for the vehicle; and
determining, based at least in part on the one or more bids and the guarantee price, a final sales price of the vehicle at the end of the timed auction, wherein the final sales price comprises (1) a highest bid from the one or more bids in the timed auction that is at least greater than or equal to the guarantee price; or (2) the guarantee price if none of the one or more bids is greater than or equal to the guarantee price.

13. The one or more computer-readable media of claim 12, the operations further comprising receiving an indication of acceptance or rejection of the final sales price from the computing device associated with the seller of the vehicle.

14. The one or more computer-readable media of claim 12, wherein the guarantee price comprises a minimum bid price for the vehicle in the timed auction.

15. The one or more computer-readable media of claim 12, wherein the guarantee price comprises a reserve price for the vehicle in the timed auction.

16. The one or more computer-readable media of claim 12, wherein the information associated with the vehicle is received from the seller of the vehicle via the computing device associated with the seller of the vehicle.

17. The one or more computer-readable media of claim 12, wherein the information associated with the vehicle is received from a third-party service provider via a third-party service provider computer.

18. The one or more computer-readable media of claim 12, wherein the guarantee price is based at least in part on a value of the vehicle as provided by the third-party service provider via the third-party service provider computer.

19. The one or more computer-readable media of claim 12, wherein the guarantee price comprises at least one of a specific amount, a range of amounts, or at least a percentage of an amount.

20. The one or more computer-readable media of claim 12, wherein the guarantee price is acceptable at a future date and time.

21. A system, comprising:
at least one memory that stores computer-executable instructions;
at least one processor configured to access the at least one memory, wherein the at least one processor is configured to execute the computer-executable instructions to:
receive information associated with a vehicle;
determine, based at least in part on the information associated with the vehicle, an offer price for the vehicle at a future date and time;
determine, based at least in part on the information associated with the vehicle, the offer price, and/or the future date and time, a fee to redeem the offer price at the future date and time;
provide the offer price for the vehicle at the future date and time and the fee to redeem the offer price at the future date and time to a computing device associated with a seller of the vehicle;
receive an indication of acceptance or rejection of the fee to redeem the offer price at the future date and time from the computing device associated with the seller of the vehicle, wherein acceptance of the fee comprises a put option for the vehicle; and
receive an indication on or before the future date and time of acceptance or rejection of the offer price for the vehicle.

22. The system of claim 21, wherein after the acceptance of the fee creating the put option, the vehicle is placed in a timed auction.
